(19) United States
(12) Patent Application Publication
(10) Pub. No.: US 2010/0005952 A1
(43) Pub. Date: Jan. 14, 2010

(54) Method and apparatus for teaching keyboard persons with developmental disabilities

(76) Inventor: Maria LaMon, West Islip, NY (US)

Correspondence Address: JAMES M. LOEFFLER, ESQ. PLLC, COURTHOUSE CORPORATE CENTER, 320 CARLETON AVENUE, SUITE 6800, CENTRAL ISLIP, NY, 11722, US

(21) Appl. No.: 12/455,562

(22) Filed: Jun. 2, 2009

Related U.S. Application Data
(60) Provisional application No. 61/130,667, filed on Jun. 2, 2008.

(51) Int. Cl. G09B 15/08

(52) U.S. Cl. 84/478

(57) ABSTRACT

A method and kit for teaching keyboard to children and/or adults with autism and developmental disabilities. A simplified, backwards approach to teaching keyboard, where the student learns how to play songs first (by way of letter and/or picture connection) and theory comes at a later time. The method is a visual and auditory approach to teaching keyboard which incorporates Applied Behavioral Analysis for learning and behavior modification. The method and kit includes specific flash cards (used in discrete trials), games (play therapy), and a special designed music/song book (oversized staff paper with oversized notes). This method and kit helps the student to stay on task and master the skill of playing the keyboard (piano), which gives the student an instantaneous sense of accomplishment without any (or minimal) frustration.

### CROSS-REFERENCE TO RELATED APPLICATIONS

This application claims the benefit of U.S. Provisional Patent Application No. 61/130,667, filed Jun. 2, 2008.

### BACKGROUND OF THE INVENTION

1. Field of the Invention

The present invention relates to educational tools, manipulates and a theoretical approach to teaching the skill of playing keyboard, and, more specifically, to educational tools, manipulates and a theoretical approach to teaching the skill of playing keyboard to children and/or adults with autism and other developmental disabilities.

2. Description of the Background Art

The teaching approach for traditional piano/keyboard instruction is generally a very structured, theoretical method of teaching. One must be able to have the attention span and learning capabilities to understand the complexities involved in learning how to play keyboard (piano).

Many children and adults on the autism spectrum and/or other developmental disabilities do not have the attention, social skills, and/or learning capabilities to adhere to the traditional style of teaching. Accordingly, in order to give every student an opportunity to learn, there is a need in the art for a method to effectively teach persons having developmental disabilities to play the keyboard in a manner which fits the students' style of learning.

Children with autism and/or developmental disabilities have a unique connection with music. Many, if not all love music and having perfect pitch (or close to), seems to be more common in children with autism then with a-typical children. This can be due to their ability to have, what appears to be, a photographic memory where the pitch of the note is memorized. It is common to find these children fiddling on the keyboard (piano) and figuring out a song or tune they hear. It is also common to find these children singing all the words to a song (Echolalia—the imitation of sounds and words produced by others), yet they may not be able to converse with words in a typical daily conversation.

Music, and the ability to play keyboard (piano), can be a way to “reach into their window”. It is not only educational, it is a tool that helps these children with self esteem, fine motor skills, eye-hand coordination, socialization, language, attention and expression. Piano instruction gives the student an opportunity to not only listen to music, but it is also an opportunity to engage and create the music themselves (expression).

Many systems and aids have been proposed for teaching the musical scale to young children. A number of these systems have utilized colors and/or colored objects, while others have taken the form of card games. Illustrative examples of earlier approaches include those set forth in the following U.S. patents:

U.S. Pat. No. 4,819,539 (Searing) discloses a system which employs display cases having horizontal dividers which represent the lines on a staff. The cases hold flash cards showing objects having names which begin with letters which correspond with the positions on the scale, i.e., a flash card showing a pair of gloves is provided for the note “G”. A cassette tape device generates the noun, the name of the note, and then the sound of the note, after which the student selects another card; the time required to remove all of the cards is clocked by the device.

U.S. Pat. No. 2,807,183 (Ney) discloses a portable dummy keyboard having a frame 56 which displays the musical staves above the keyboard. The frame supports wires on which colored markers representing each of the keys can be mounted.

U.S. Pat. No. 2,447,213 (Sledge) discloses a color code system in which each of the lines on a staff is provided with its own color, i.e. the “G” line is colored blue, and a small blue house is mounted at the end of the line, drawing the analogy to a street.

Markers in the shape of animals having names which begin witch the appropriate letters (i.e., a goose for “G”, a bear for the note “B”, and so forth) are mountable on the display board and are colored to match the appropriate note line. For example, the goose is colored blue (and is also marked with the letter “G”), and the child is taught that the goose lives in the blue house at the end of the blue street. After the child learns the line with which each note is associated, the colored house for that line is moved to the appropriate key on a dummy piano keyboard made up of blocks.

U.S. Pat. No. 2,236,638 (Adams) discloses a device comprising a series of interfitting dummy key blocks which are identical in shape to the keys of a piano, but which are organized according to a color arrangement.

U.S. Pat. No. 2,315,793 (Jay) discloses a system which is somewhat similar to that of Sledge, in that each note has associated therewith the image of an animal whose name begins with the letter which represents that note; i.e., a picture of the head of a goat appears with the note “G” on the printed musical score, along with the letter “G” itself. This same symbol is also displayed on the sides of a hollow toy block which houses swinging chimes which emit the sound of the appropriate note when the block is shaken.

Although these, and other methods, exist for teaching the music scale to young children, these methods do not overcome the intricacies associated with teaching keyboard to persons having autism and/or developmental disabilities. Thus, there is a need for a creative approach to teaching keyboard (piano) to students with autism and/or developmental disabilities.

### SUMMARY OF THE INVENTION

The present invention uses a variety of teaching tools and manipulatives that help to work around learning deficits, socialization and behavior issues often associated with a student with autism and/or developmental disabilities. It teaches the student how to play first, then by use of game play, the student then learns note reading and theory. By teaching the student to learn to play first, it gives that student an instantaneous sense of accomplishment without frustration.

It is an object of the present invention to provide a method of teaching a student with autism and/or developmental disabilities how to play the keyboard (piano). Once the student has mastered this program, the teacher can then build onto the program by incorporating traditional methods of teaching (depending on the level the student is at). This invention serves as a tool for music teachers, special education teachers, and parents.

Alternative embodiments of the present invention are described herein. The first embodiment utilizes letter connection (C, D, E, F, G, A, B). An alternative embodiment utilizes picture connection (Cat—middle C, Dog—D, Elephant—E, Frog—F, Gorilla—G. Ant—A, Bee—B, Camel—C). The picture connection can be used with students who are not able to identify the note letters (C, D, E, F, G, A, B). It is also contemplated that, depending on the level of the child and/or behavioral and motivational factors involved, the picture connection embodiment may be used prior to beginning the student on the letter connection embodiment. The goal with each embodiment of the present invention is that the student is learning to play the keyboard (piano). The benefits of this method of teaching also include improved self esteem, fine motor skills, eye-hand coordination, spontaneous and receptive language, and increased attention span and expression.

The apparatus in accordance with an embodiment of the present invention comprises a variety of tools and manipulatives. The tools and manipulatives may comprise a kit which may be utilized with one or more of the methods of teaching a person with developmental disabilities to play the keyboard in accordance with the present invention. The kit may include one or more of the following items: a special designed music/song book—used for playing songs on the piano by an instant visual match to the stickers on the keys; Keyboard Stickers (window clings)—identify the keys on the keyboard; Templates—used on the keyboard to help the student with letter identification; Clef Flash Cards—treble and bass clef cards are used in discrete trials to help the student recognize which hand to use (treble clef—right and bass clef—left); “Hands On Keys” Flash cards—used in discrete trials to reinforce hand placement on the keyboard (piano keys); “Find The Note” flash cards—used in discrete trials to help the student find the note with the correct hand (treble clef—right, and bass clef—left); Discrete Trial Record Sheet—used for recording and measuring student tasks; Reference Chart—used as a reference guide for keyboard stickers and hand placement on the keys; Letter Hunt Flashlight Game—used for letter note recognition, note order placement, and reinforcement; Keyboard Chart Matching Game—used for letter note recognition, note order placement, and reinforcement; “Name That Note” Game—used for note recognition and reinforcement; and Memory Game—used for note recognition and reinforcement.

The invention is not limited to the above-described embodiments, and various changes are possible without departing from the principles set forth herein.

The above is a brief description of some deficiencies in the prior art and advantages of the present invention. Other features, advantages and embodiments of the invention will be apparent to those skilled in the art from the following description of the drawings.

### BRIEF DESCRIPTION OF THE DRAWINGS

The invention will become more clearly understood from the following detailed description in connection with the accompanying drawings, in which:

FIGS. 1, 1A, 1B and 1C are diagrammatical views of pages from the special designed music/song book in accordance with an embodiment of the present invention;

FIGS. 2A and 2B are diagrammatical views of the keyboard stickers for the piano keys, in accordance with an embodiment of the present invention;

FIGS. 3A and 3B are diagrammatical views of templates for the piano keys in accordance with an embodiment of the present invention;

FIG. 4 is a diagrammatical view of the Clef Flash Cards in accordance with an embodiment of the present invention;

FIGS. 5 and 5A-G are diagrammatical views of the “Find The Note” flash cards in accordance with an embodiment of the present invention;

FIGS. 6, 6A and 6B are diagrammatical views of discrete trial record sheets in accordance with an embodiment of the present invention;

FIGS. 7A and 7 B are diagrammatical views of the Reference Charts in accordance with an embodiment of the present invention;

FIGS. 8, 8A, 8B and 8C are diagrammatical views of the tools used for the Letter Hunt Flashlight Game in accordance with an embodiment of the present invention;

FIGS. 9A and 9B are diagrammatical views of the Keyboard Chart Matching Game in accordance with an embodiment of the present invention;

FIG. 10 is a diagrammatical view of the “Name That Note” game in accordance with an embodiment of the present invention; and

FIG. 11 is a diagrammatical view of a “Hands On Keys” flash card in accordance with an embodiment of the present invention.

### DETAILED DESCRIPTION OF THE PREFERRED EMBODIMENTS

The following description is presented to enable one of ordinary skill in the art to make and use the invention and is provided in the context of a patent application and its requirements. Various modifications to the preferred embodiments will be readily apparent to those skilled in the art and the generic principles herein may be applied to other embodiments. Thus, the present invention is not intended to be limited to the embodiment shown but is to be accorded the widest scope consistent with the principles and features described herein.

The method of teaching keyboard in accordance with the present invention is based, in part, on the use of Applied Behavioral Analysis (ABA). ABA is the science of applying experimentally derived principles of behavior to improve socially significant behavior. ABA takes what we know about behavior and uses it to bring about positive change (Applied). The behavior is analyzed within the environment to determine what factors are influencing the behavior (Analysis). The method also incorporates a specific method of teaching used to maximize learning via discrete trials. Discrete trials include a teaching technique or process used to develop many skills, including cognitive, communication, play, social and self help skills. The method further includes game play and educational tools and manipulatives. The method and teaching tools that are used are combined to establish a unique style which is conducive for learning and are relevant in the style of learning for a student with autism and/or developmental disabilities.

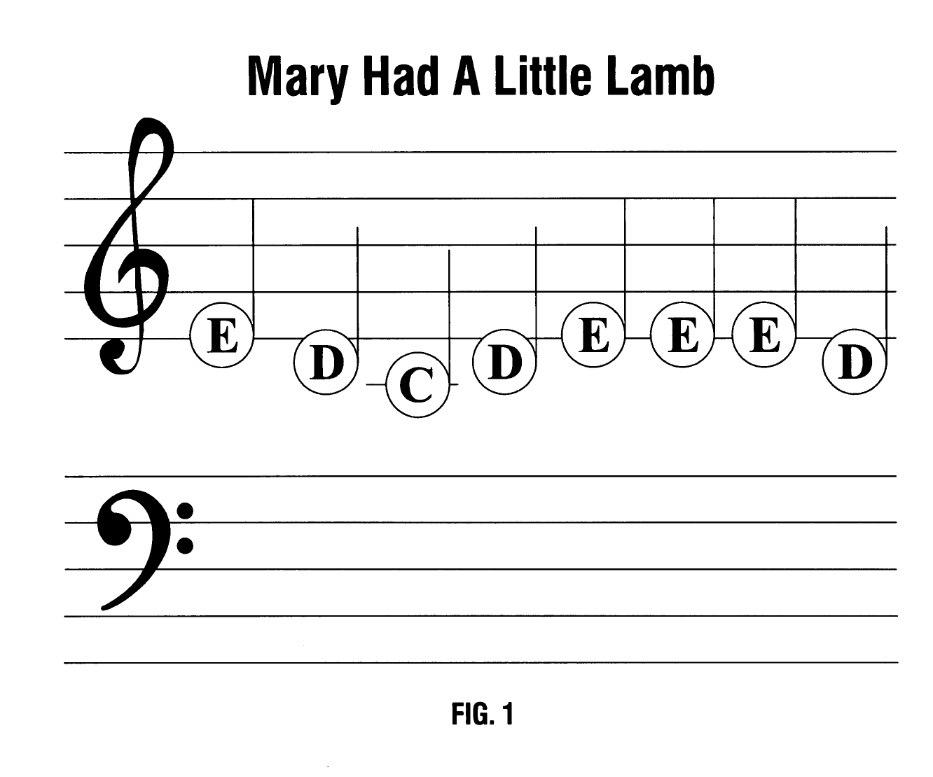

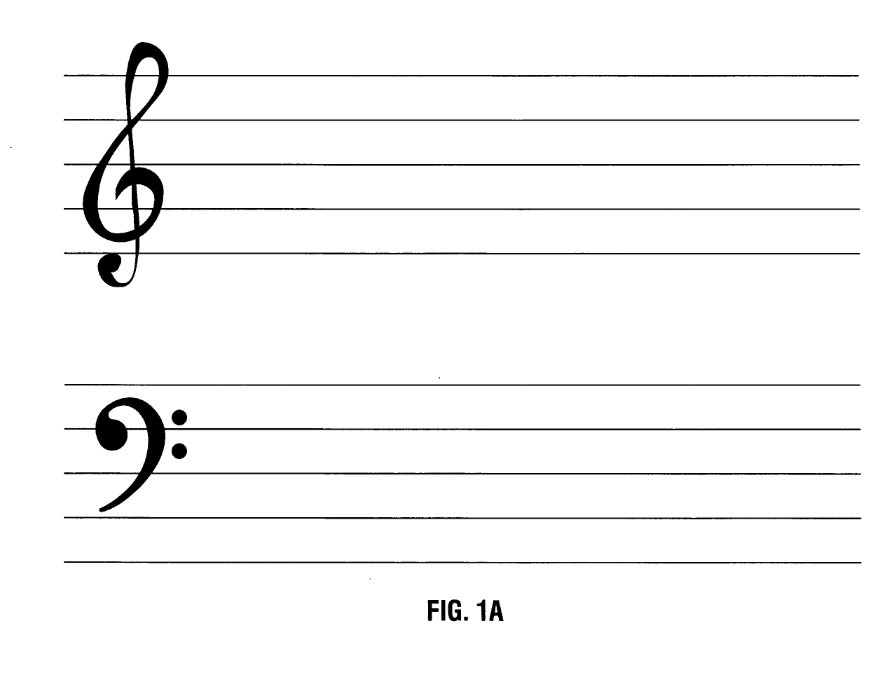

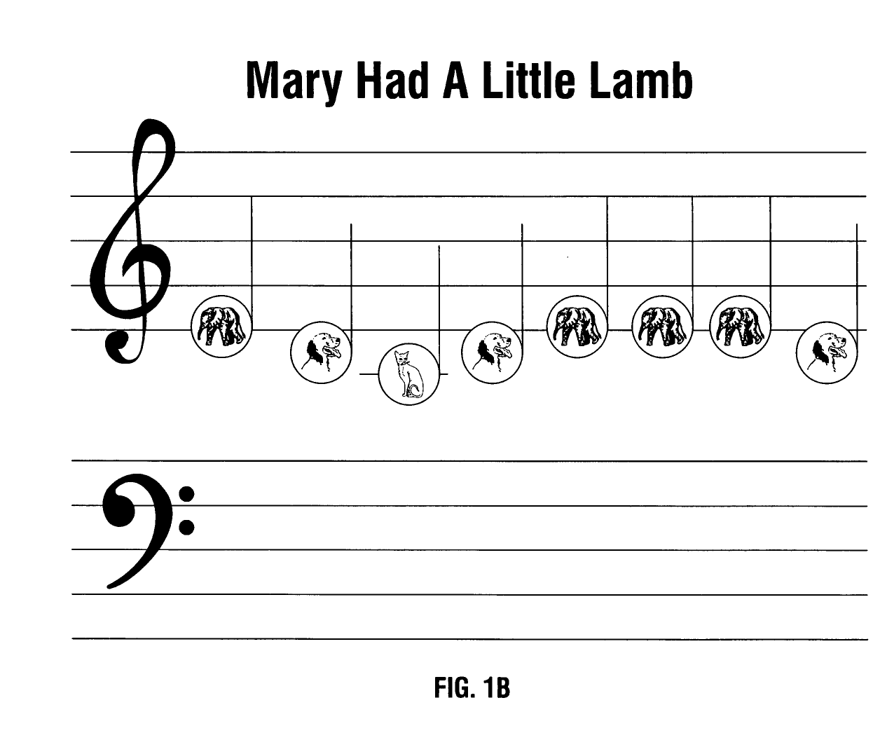

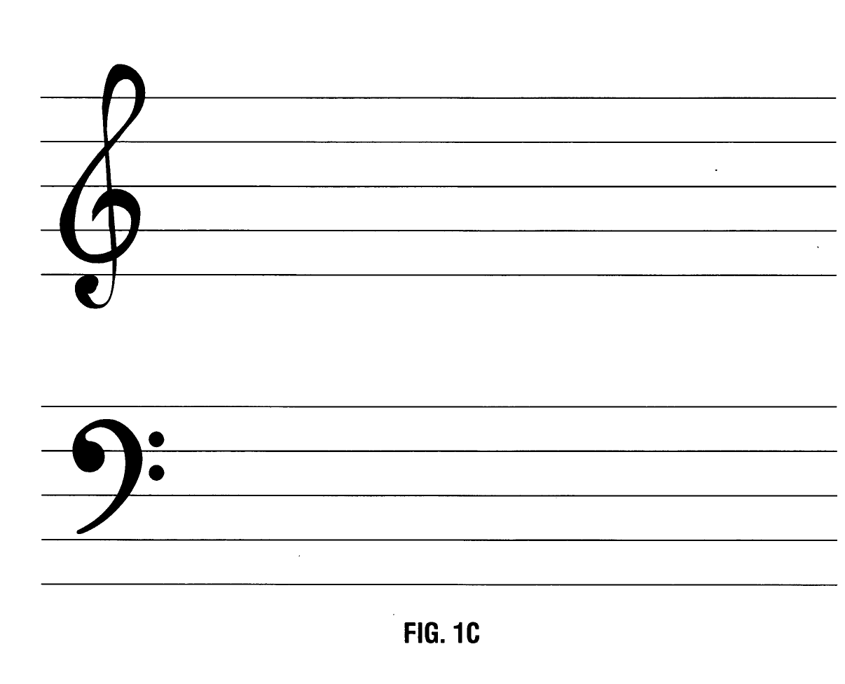

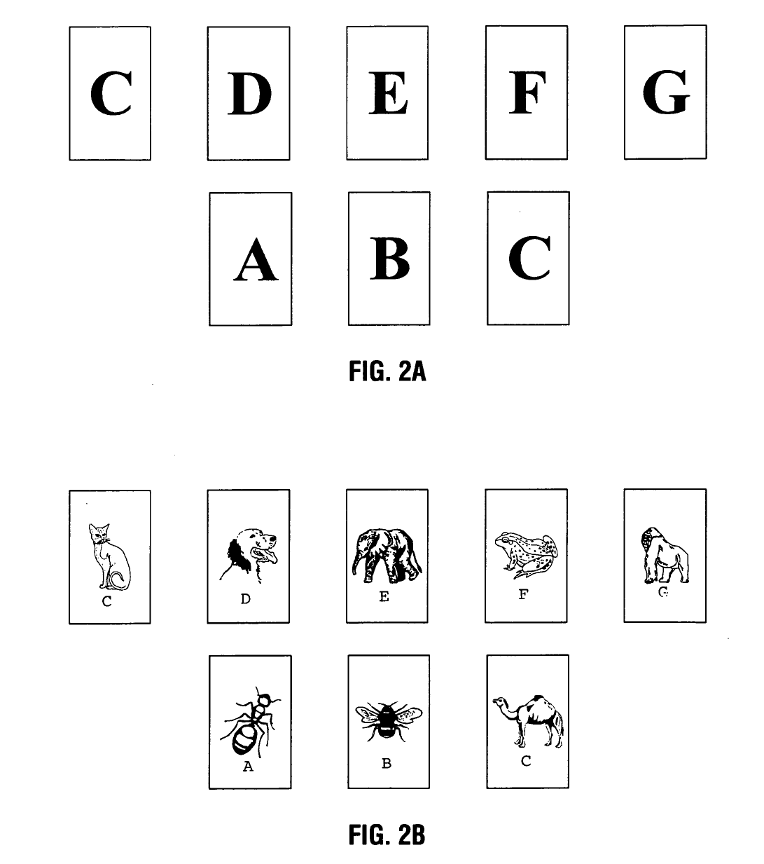

Referring now to the drawings in detail, and first to FIG. 1, a kit specifically geared for teaching children and/or adults with autism and developmental disabilities will be described. FIGS. 1, 1A, 1B and 1C are diagrammatical views of pages from the special designed music/song book in accordance with an embodiment of the present invention. As illustrated, staff and musical notes are oversized. Each page has one staff so that it is not overwhelming to the student. This allows a simplified visual match to the letters on the keys (illustrated in FIG. 2A). The notes are in black and white. However, in a preferred embodiment, the middle C is illustrated in red. Songs in the book are preferably songs that are familiar to the student which helps with learning the songs on an auditory as well as visual level.

FIGS. 2A and 2B are diagrammatical views of the keyboard stickers for the piano keys, in accordance with an embodiment of the present invention. The keyboard stickers are preferably sized to fit each piano key to cover two octaves of notes (lower C, D, E, F, G, A, B, middle C, D, E, F, G, A, B, and upper C). Again, middle C is preferably color coded in red to distinguish between the different C notes. All songs in the song book also reflect Middle C in red. Stickers are preferably made of window cling material, which adhere nicely to the keys, and also making them non-permanent for easy removal. It is contemplated that the stickers may be formed having other adhesive materials known to one having ordinary skill in the art.

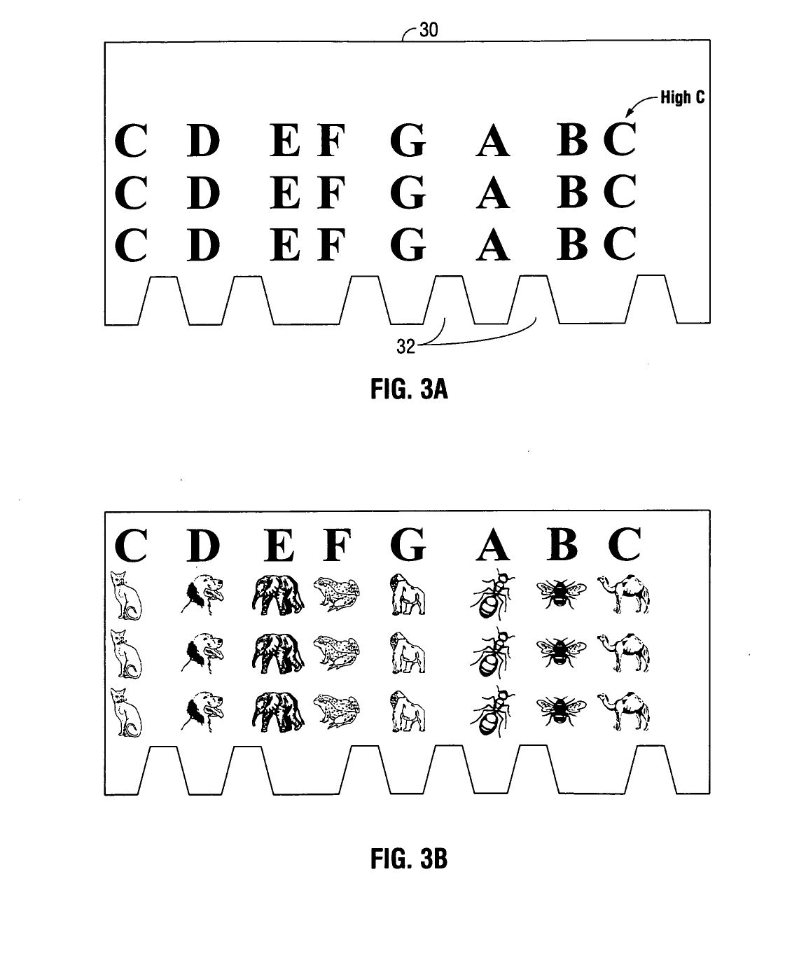

FIGS. 3A and 3B are diagrammatical views of templates for the piano keys in accordance with an embodiment of the present invention. The template 30 fits up against the back of the keys. Notches 32 are formed in the lower edge of template 30 allow the template 30 to be mounted over the black keys of the keyboard (not shown). The template enhances the visual match from letter notes in the music/song book to the notes on the keys.

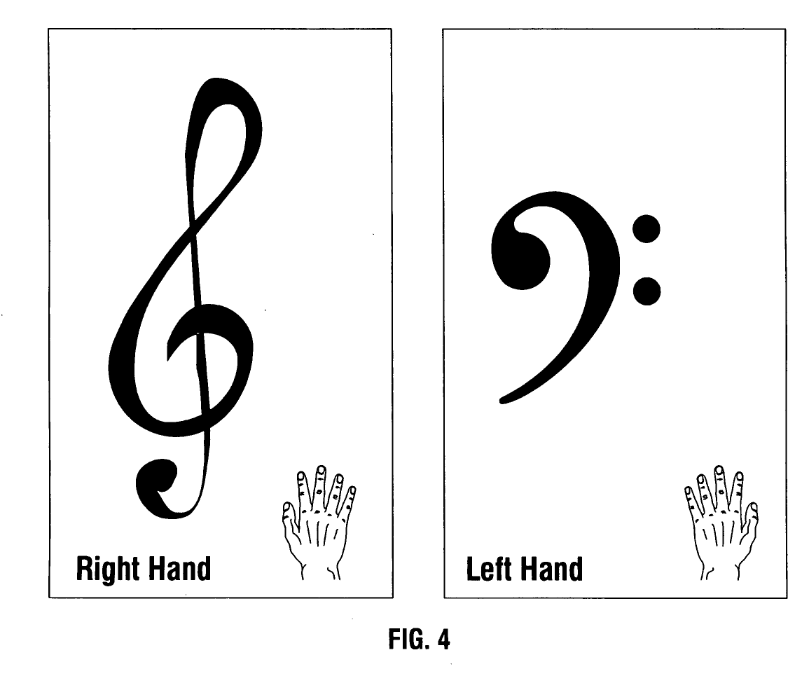

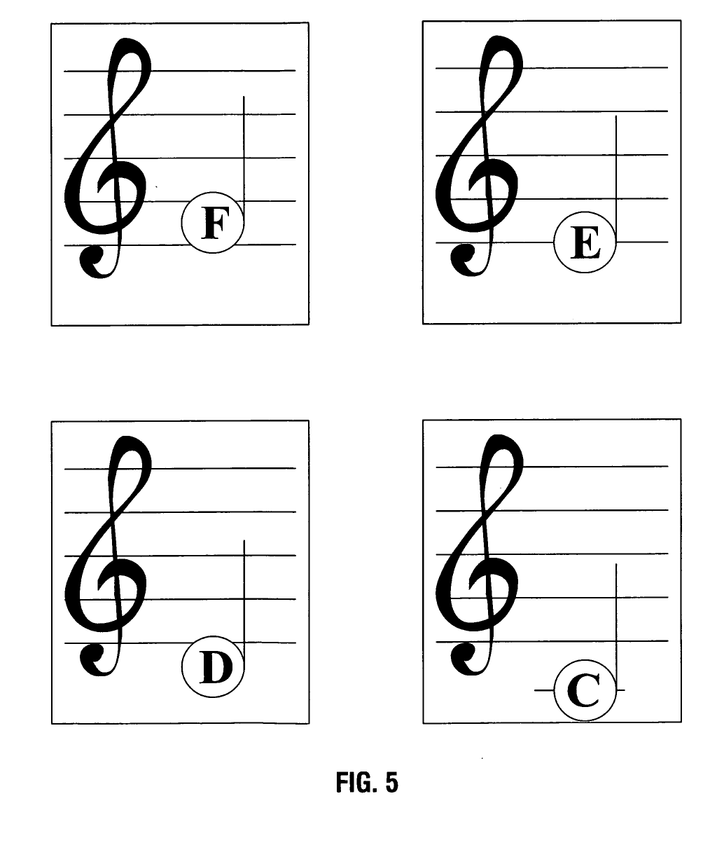

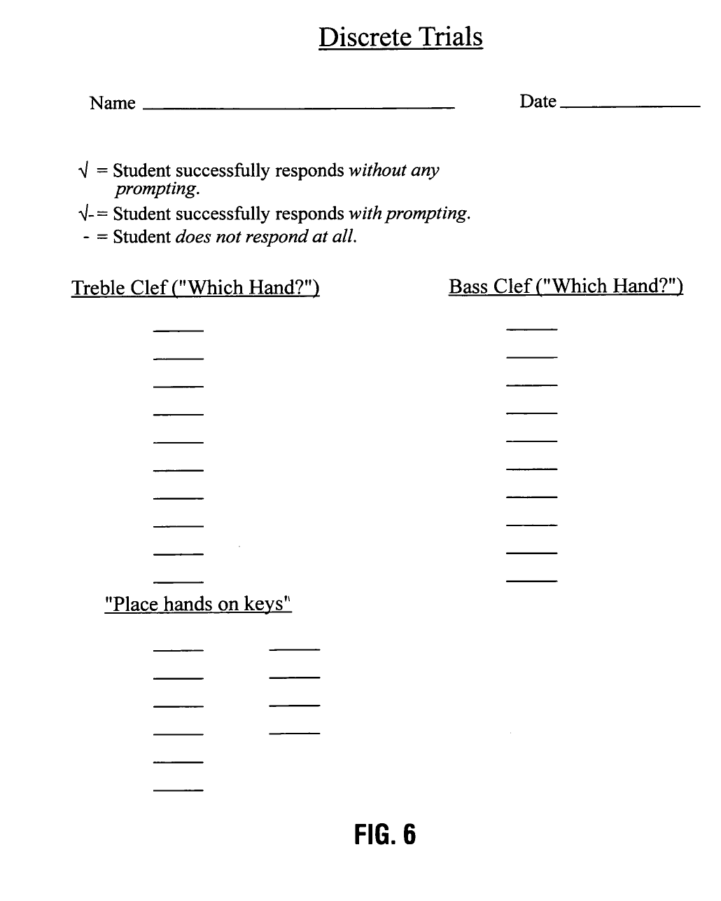

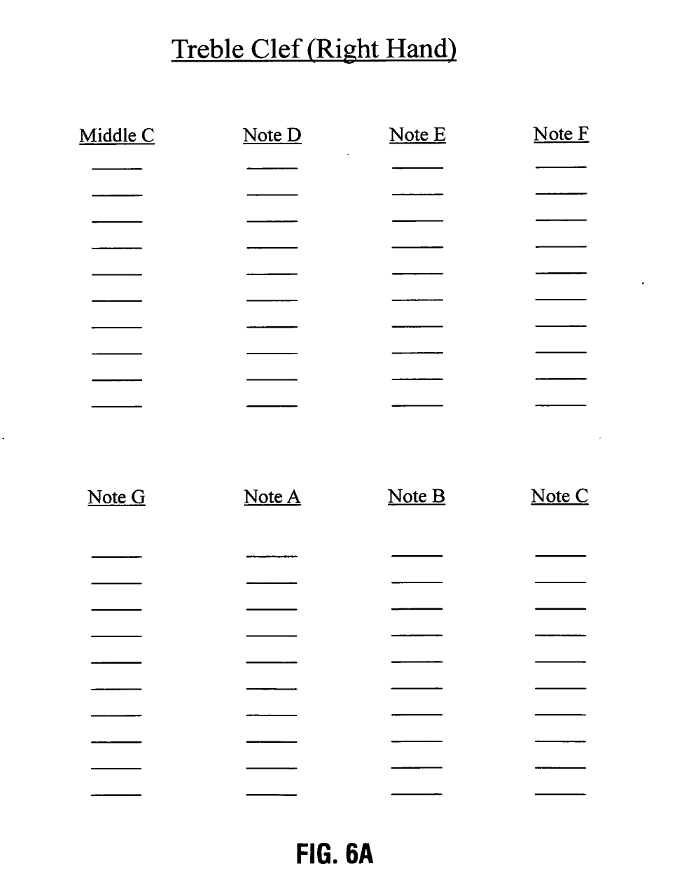

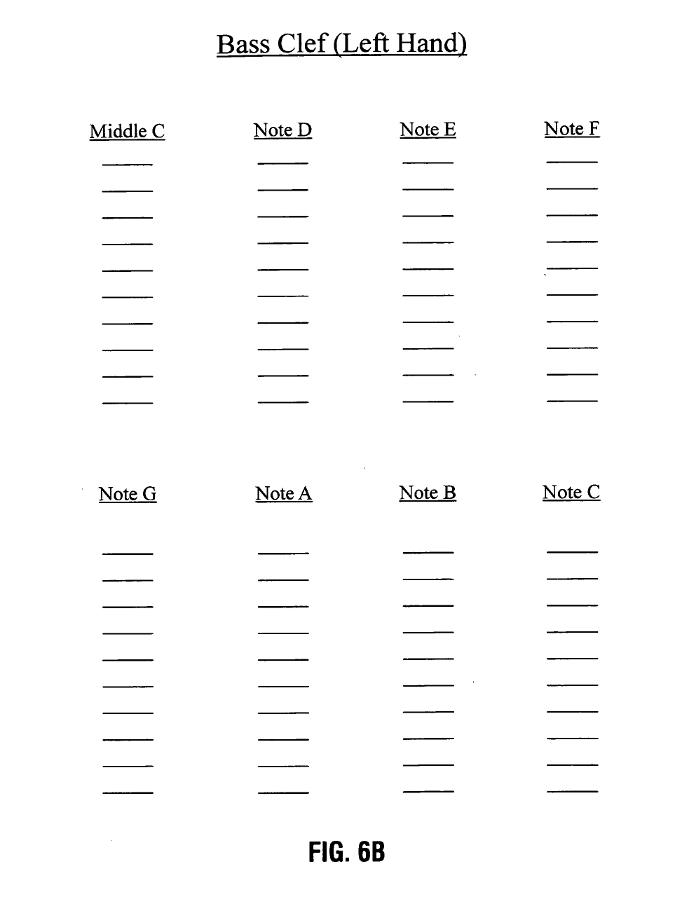

FIG. 4 is a diagrammatical view of the Clef Flash Cards in accordance with an embodiment of the present invention. Two clef flash cards 42 and 44 are included (bass clef and treble clef). These cards are used in discrete trials. Tasks are recorded and measured on the Discrete Trial Record Sheets (illustrated in FIGS. 6, 6A and 6B). The clef flash cards 42 and 44 are used to help the student identify which hand to use (right or left) when they see a specific clef sign (treble and bass clefs).

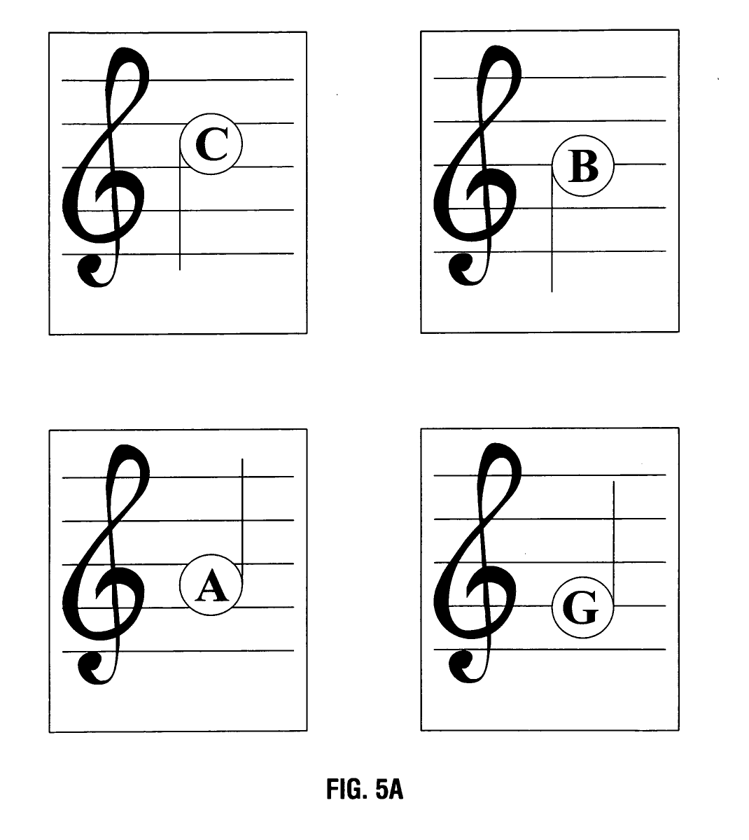

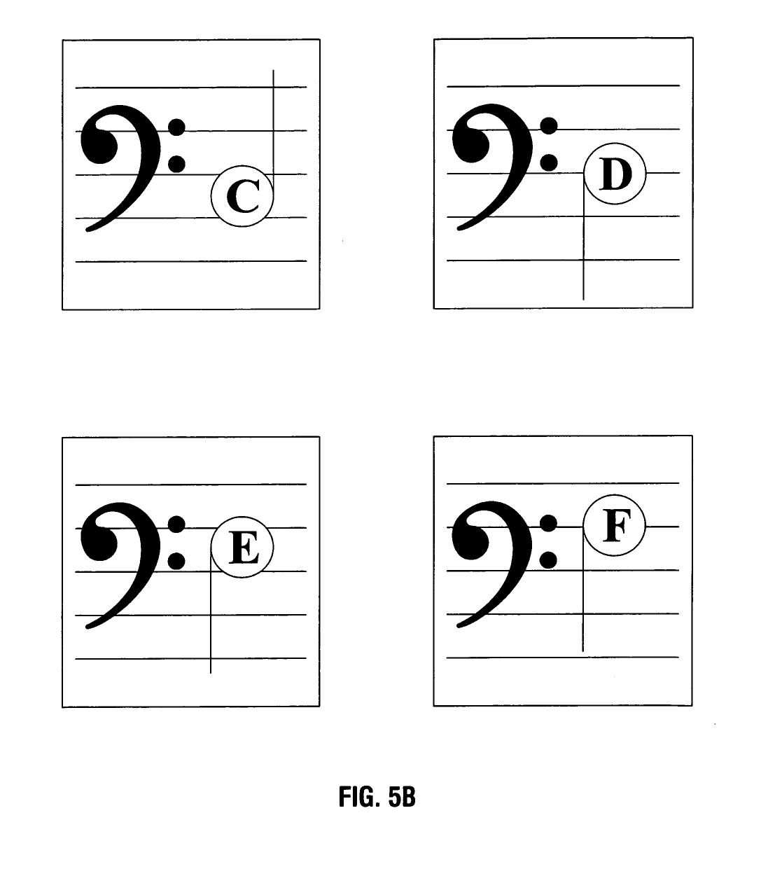

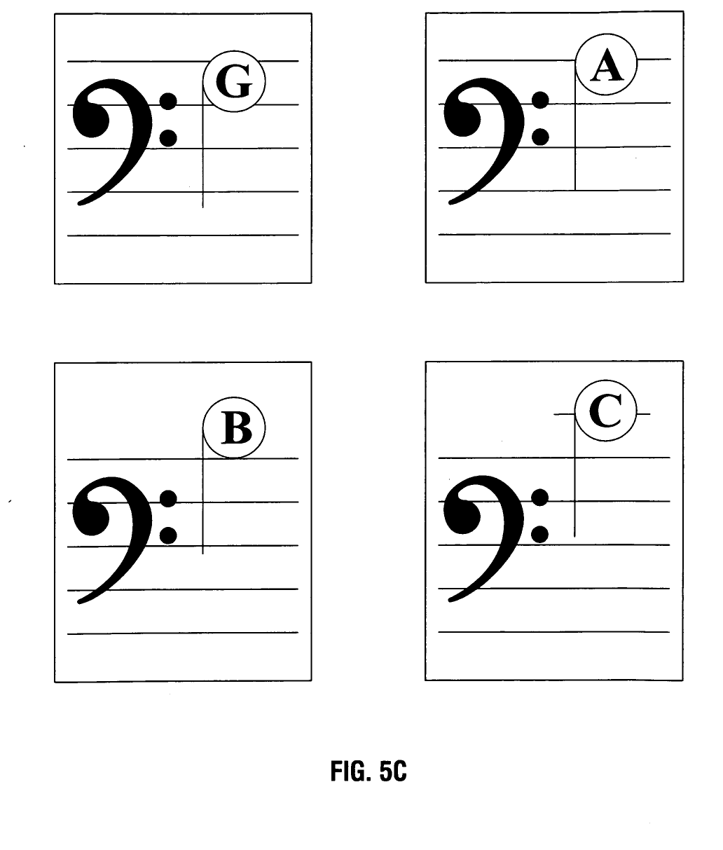

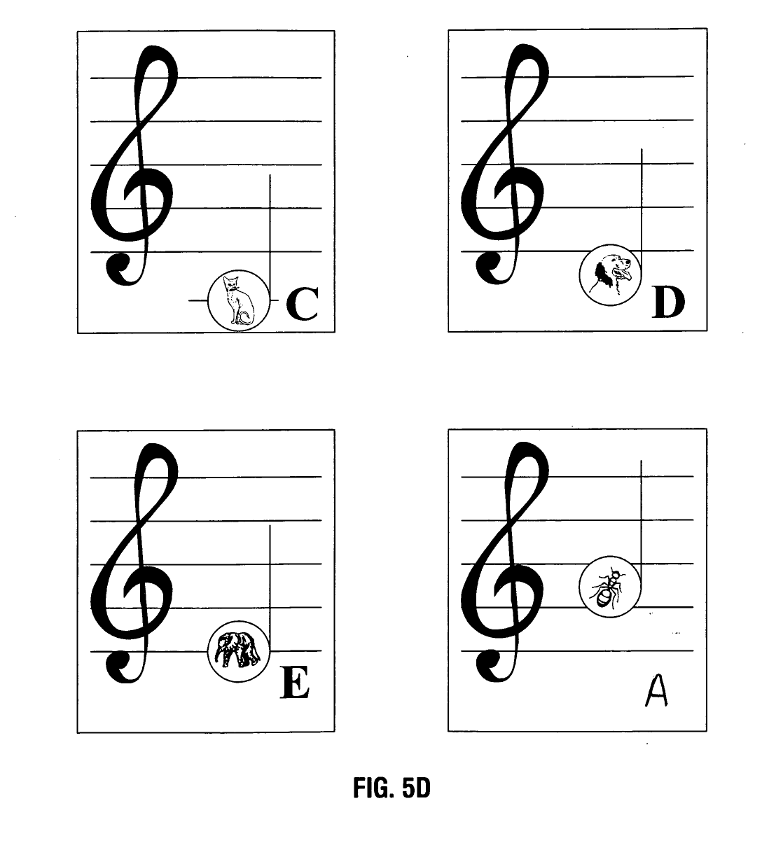

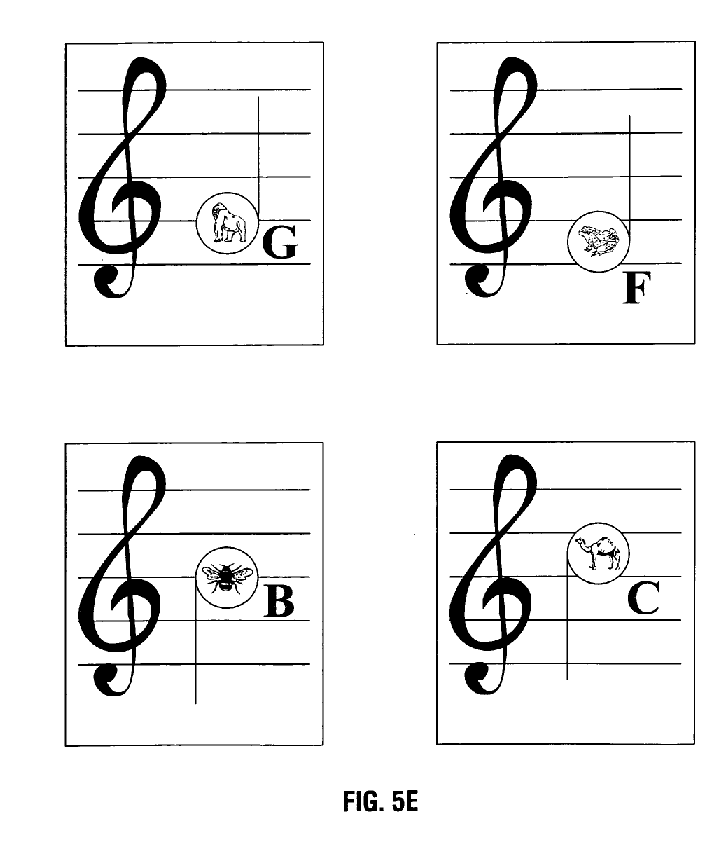

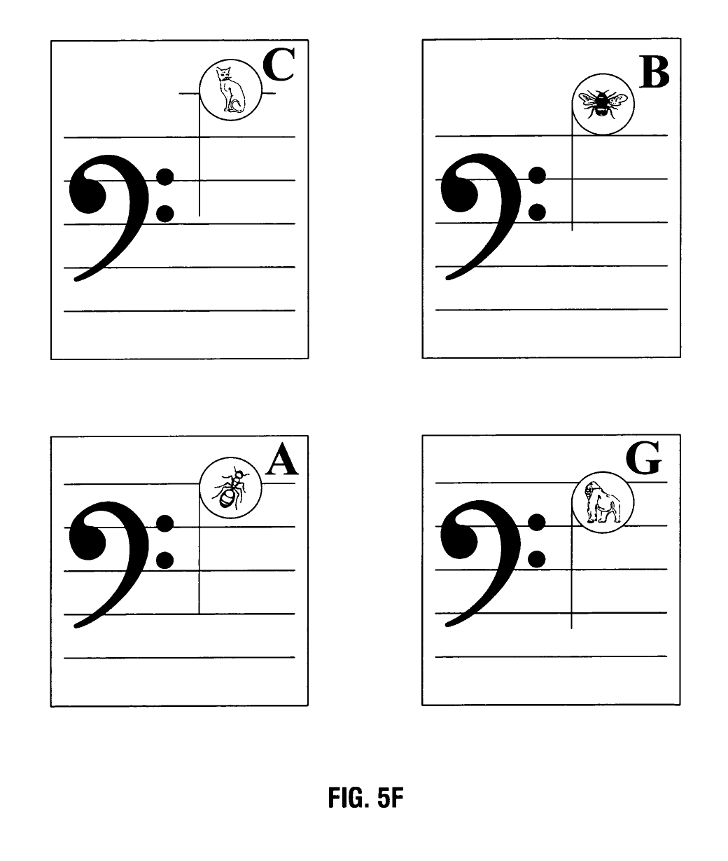

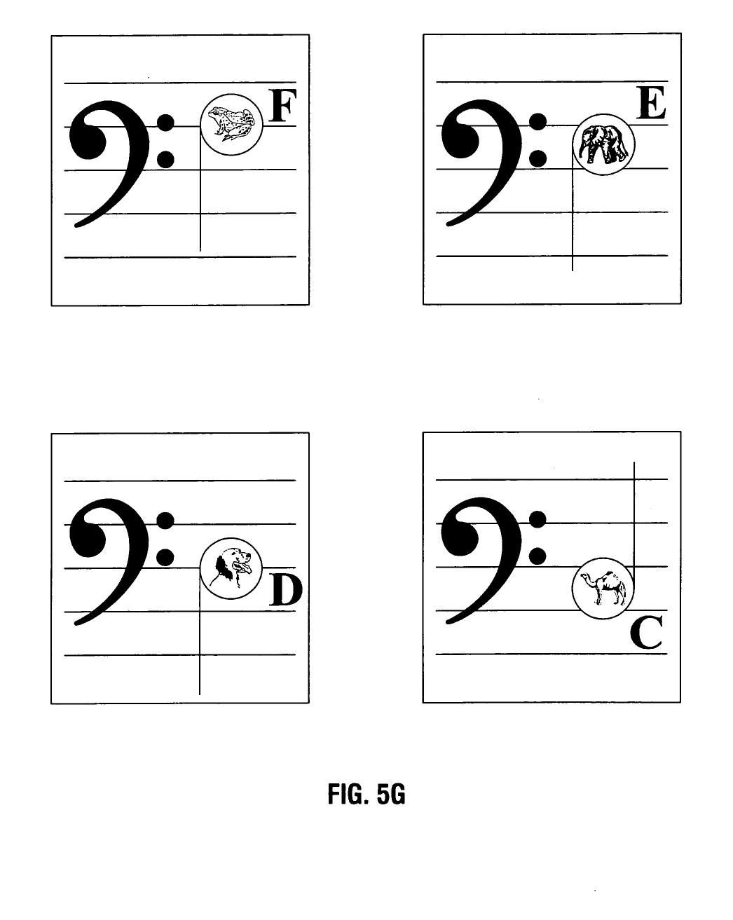

FIGS. 5 and 5A-G are diagrammatical views of the “Find the Note” flash cards in accordance with an embodiment of the present invention. Sixteen cards are preferably included with this program. Eight cards are used for the bass clef (C, D, E, F, G, A, B, and middle C) and eight cards are used for the treble clef (middle C, D, E, F, G, A, B, and C). These flash cards are also preferably used in discrete trials. Tasks are recorded and measured on the Discrete Trial Record Sheets (illustrated in FIGS. 6, 6A and 6B). These flash cards are used to help the student to: first—identify which hand to use by looking at the clef sign, and second—to find the note (that is identified on the flash card) on the keyboard using the correct hand.

It is also contemplated that the find the note flash cards may be utilized in a memory game. Two sets of “Find the Note” flash cards are used. The cards are placed on the floor face down, in no specific order. The student picks a card and then randomly picks another card to see if it matches. This is done until all matches are found. This game helps with musical note and letter recognition.

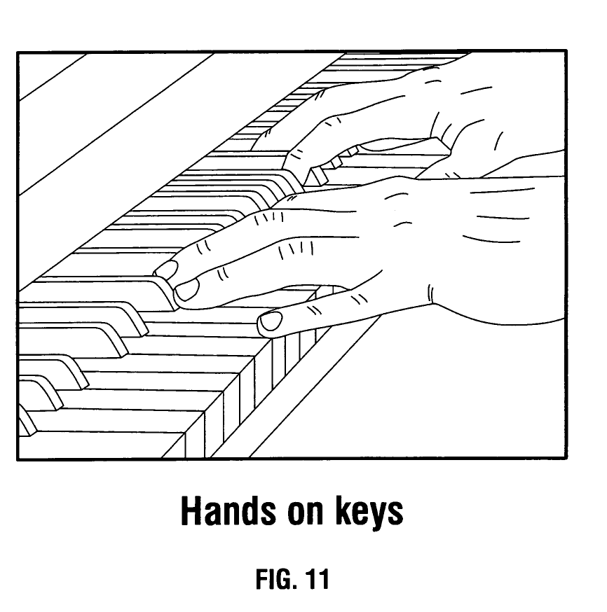

FIGS. 6, 6A and 6B are diagrammatical views of discrete trial record sheets in accordance with an embodiment of the present invention. The discrete trial record sheets are preferably used to record and measure the tasks while using the Clef Flash Cards and “Find the Note” flash cards described above, and the “Hands on Keys” flash card illustrated in FIG. 11.

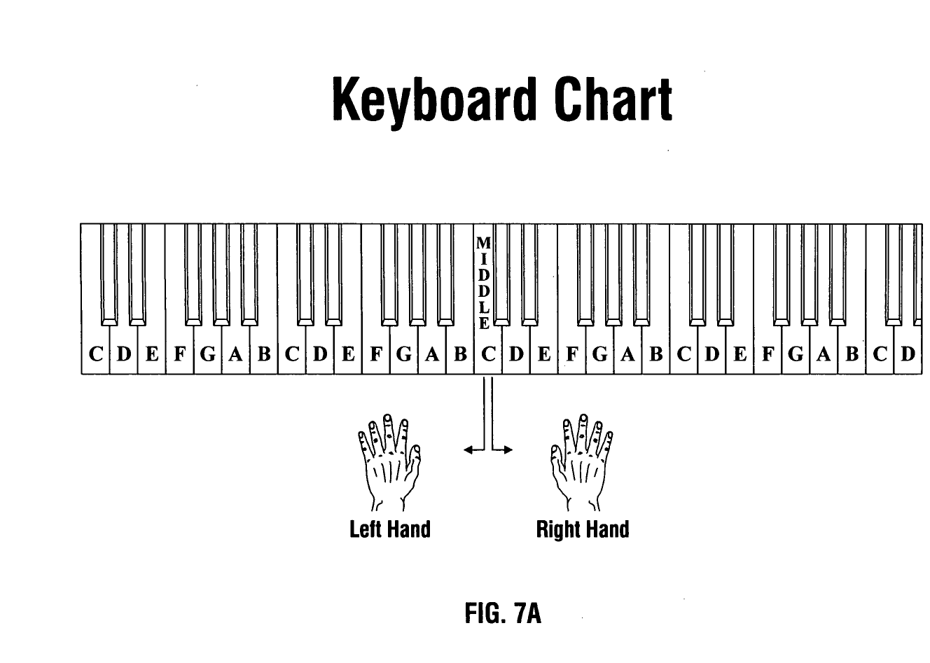

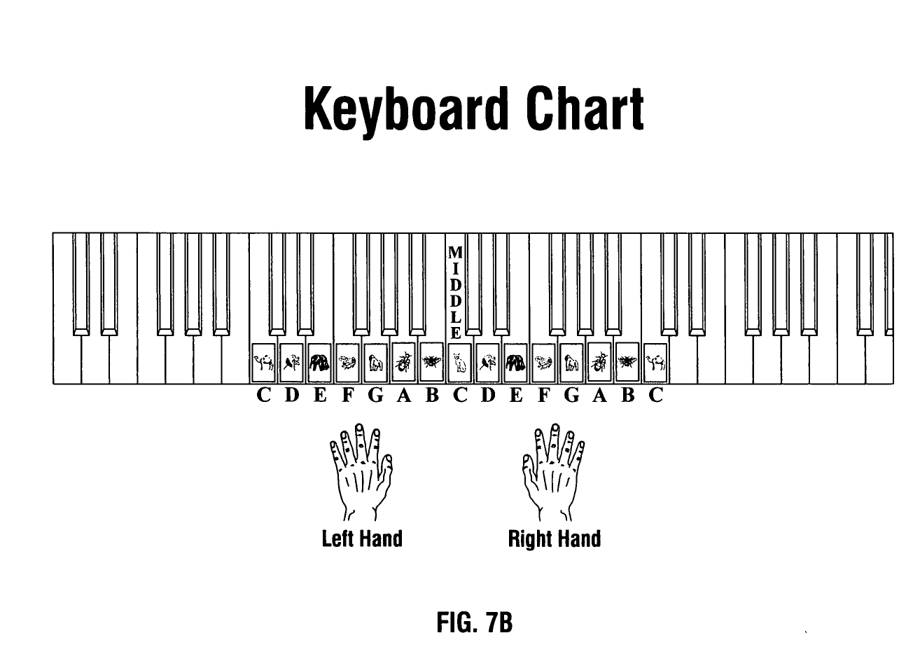

FIGS. 7A and 7 B are diagrammatical views of the Reference Charts in accordance with an embodiment of the present invention. The reference charts are used as guides for setting up the keyboard stickers (illustrated in FIGS. 3A and 3B) on the piano keys. The reference charts are also preferably utilized to distinguish between the right hand and left hand position/placement on the piano keys.

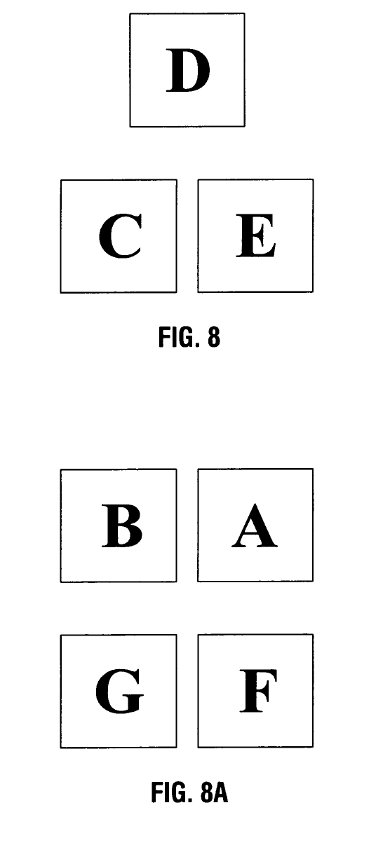

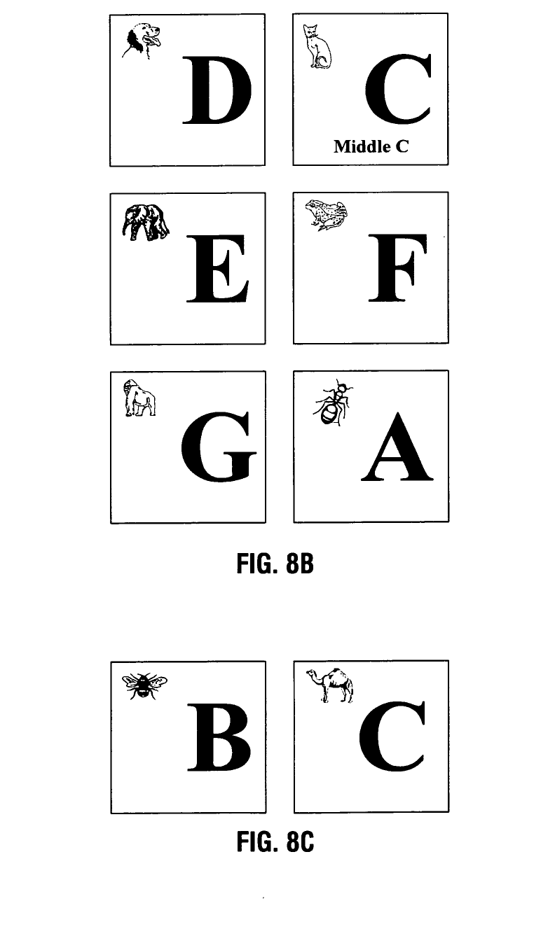

FIGS. 8, 8A, 8B and 8C are diagrammatical views of the tools used for the Letter Hunt Flashlight Game in accordance with an embodiment of the present invention. Letter cards are placed around the room where teaching is administered. Each card has a musical note letter on it (C, D, E, F, G, A, and B). Cards are attached to the walls around the room by using Velcro (or other means for attaching) so that they can be placed in different positions around the room. A small flashlight is used in this game. The student (or teacher) turns off the lights in the room. The student then shines the light on the first letter on the piano keys (note C). Then, the student looks around the room with the flashlight and finds the card to match that note (note C). The task is repeated for each consecutive note (D, E, F, G, A and B). This game helps with identification of musical notes and the order of the notes on the keys.

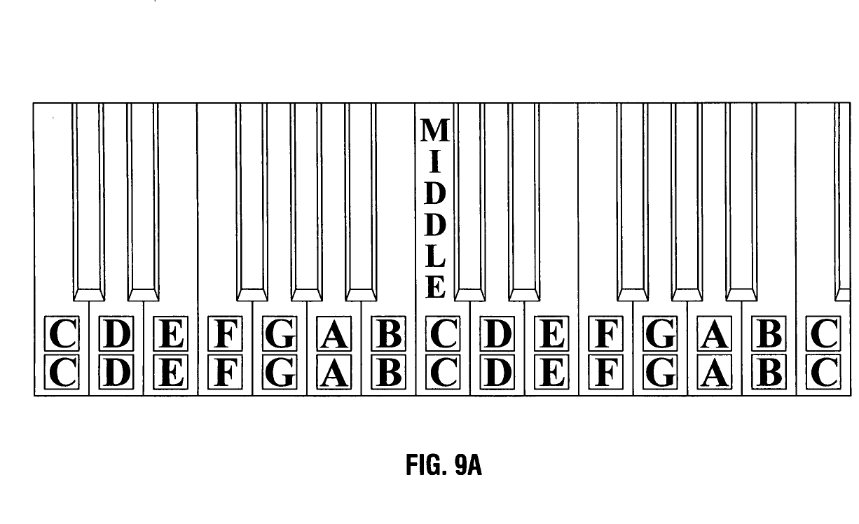

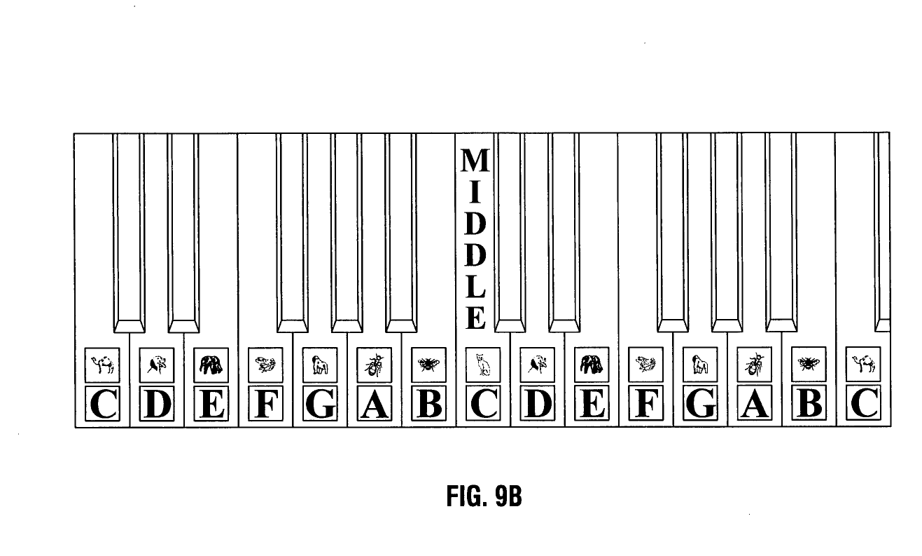

FIGS. 9A and 9B are diagrammatical views of the Keyboard Chart Matching Game in accordance with an embodiment of the present invention. The keyboard is a cardboard layout of the actual size of the 88 keys on the piano. The musical note letters are attached to the keyboard with Velcro. Two rows of letters are used for a variety of matching games. One row can be left on so the student can match the bottom row. As the student advances, both rows can be taken off and the student must match up the letters to the appropriate keys. This game helps with the recognition of the musical letter notes and the placement and order of the notes on the keys.

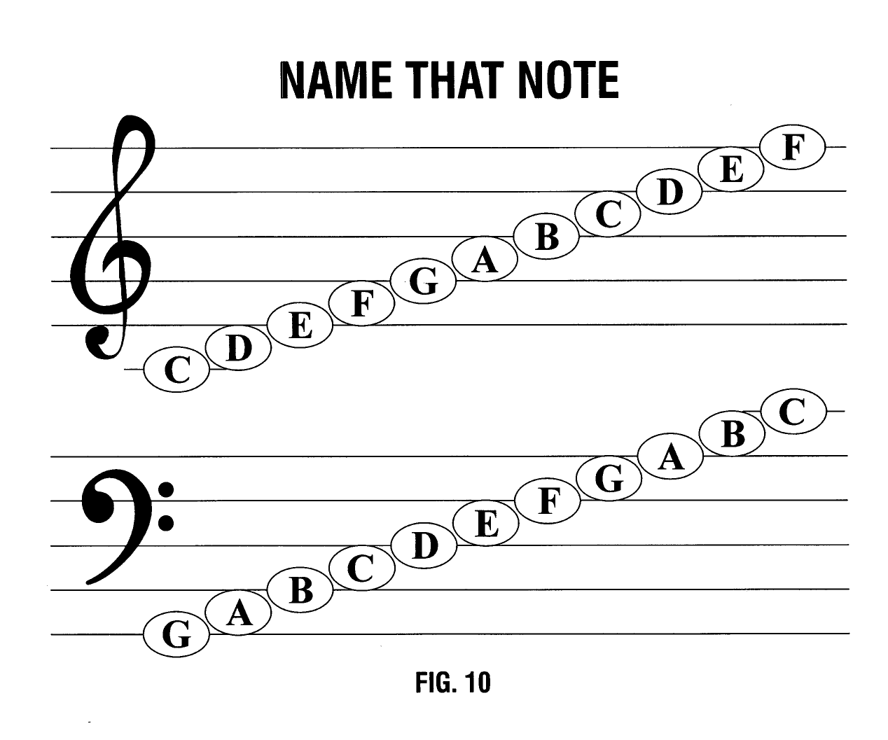

FIG. 10 is a diagrammatical view of the “Name That Note” game in accordance with an embodiment of the present invention. Each note and the clef signs are attached to the board with Velcro. The teacher removes all notes and clef signs from the board and the student then places the notes and clef signs back on the board in the correct order. This helps the students with identifying the notes on the staff for preparation of note reading.

FIG. 11 is a diagrammatical view of a “Hands on Keys” flash card in accordance with an embodiment of the present invention. The hands on keys flash card should be used in discrete trials and recorded on the discrete trial record sheets. The hands on keys flash card is used as a reinforcement and prompting manipulative to help keep the students hands positioned on the keys. Hands on keys flash cards illustrating a plurality of hand positions on the keys are contemplated.

Although the above figures were described in accordance with the use of letters and letter recognition, in an alternative embodiment of the present invention the letters and letter recognition may be replaced by pictures and picture recognition as illustrated and described. For example, the stickers illustrated in FIG. 2B include a corresponding picture as well as the letter note for a visual connection (Cat—middle C, Dog—D, Elephant—E, Frog—F, Gorilla—G, Ant—A, Bee—B, Camel—C).

The letter connection embodiment is preferably geared to students who have the ability to identify letters (visually and/or verbally). The picture connection embodiment is preferably is geared to students who do not have the ability to identify letters (visually and/or verbally). The picture connection embodiment program should be used temporarily to prepare the student for the letter connection program.

A method for teaching children and/or adults with autism and developmental disabilities is disclosed in accordance with the present invention. The method of teaching keyboard (piano) in accordance with the present invention is based on a visual and auditory connection, rather then the traditional method of having to read music, which can be a difficult task for special learners. This program is a backwards approach to teaching keyboard (piano) where the student learns to play songs first (by letter and/or picture connection), and note reading and theory is taught at a later time.

A first step in the method for teaching persons with autism and developmental disabilities how to play keyboard is to provide a classroom environment (instructional room) which is conducive to learning. Many students who have autism and developmental disabilities are easily distracted. The instructional room should be simple and non-distracting.

The following should be available in the instructional room and used (when needed) for behavior modification and re-directing students that are easily distracted (Applied Behavioral Analysis). Token Board System—helps keep the student motivated, focused, and on task. Visual Cards (PECS—Picture Exchange Communication System)—for students who are non-verbal or require prompting. Positive reinforcement—hang a sign up that states “Today I am working for . . . . ” The student can pick what he/she is working for. It may be a tangible or non-tangible item. Preferably, two treasure chests are maintained in the instructional room. One may be filled with lollypops and the other may be filled with small trinkets. When the student comes in for his/her lesson, a visual card (showing what they are working for) is hung next to the “I am working for . . . . ” statement to remind them what they are working for. Throughout the lesson, the student should be reminded of their reward to help keep them on task. Stickers—keep plenty of stickers on hand. These are great reinforces to use throughout the lesson. It helps keep the student focused and on task. Verbal praise—it is so important to focus on the positive and redirect the negative. The students thrive on verbal praise. Stay Positive—each student is unique in his/her own needs, learning style and behaviors. Time should be taken out to get to know the students and their caretakers. This will help the program to be a success. Patience—A virtue.

Another step in the method for teaching persons with developmental disabilities to play the keyboard is setting up the keyboard. As described above, stickers are included with the kit (see FIGS. 2A and 2B). There are 15 stickers to cover two octaves of keys, which includes Middle C. Middle C is in red to distinguish between the different C notes. Middle C is important for hand placement on the keys. Stickers should be placed on the keys by referring to the reference chart included in this program (see FIGS. 7A and 7B). The program starts with the basics of piano playing. There is no need to worry about sharps and flats at this time (to be taught at a later time). The goal is to teach the student to play melodies. Set up the template (FIGS. 3A and 3B) along the back of the keys. The template and stickers give the student a secure visual guide. The reference chart should be placed by the keyboard (piano) in eye's view of the student.

The first lesson should begin by giving the student a sense of accomplishment. It is not important to teach fingering (unless the student has a willingness to adapt without frustration), time signatures, note values, and bar lines in the beginning. These aspects will follow as the lessons progress. By the end of the first lesson, it is important that the student is playing melodies from the music/song book (see FIGS. 1A and 1 B).

Begin by placing the special designed music/song book at the keyboard (piano). Open the book to the first song of “Mary Had A Little Lamb”. Also, begin with only placing the right hand stickers (FIGS. 2A and 2B) on the keys (the first few songs they will learn will be only right hand notes). Prompt the student by showing the letter matches from the notes in the book to the notes on the keys. Example—E, D, C, D, E, E, E, D, D, D, E, E, E, E, D, C, D, E, E, E, C, D, D, E, D, C. By matching these letters to the notes on the keys, the student has just played their first song (Mary Had A Little Lamb). Continue with the next few songs in the book which are right hand notes only. Continue prompting to show the student how to match the letter in the book to the notes on the keys, until they are completing the task independently. Once they have mastered this task, it is time to put the left hand stickers on the keys. The student is now ready to begin songs with left hand notes (songs are introduced in the special designed music/song book—FIGS. 1A and 1B). Before teaching a new song, it is important for the teacher to play the song first so that the student can hear the song and is familiar with the melody. All songs in the music/song book are familiar public domain songs that are easily recognized.

Another step is to reinforce the use of the right and left hand. The program includes visual cards (FIG. 4) to help the student recognize the correct hand to use. Use these in discrete trials and measure the task on the Discrete Trial Record Sheets (FIGS. 6, 6A and 6B). The student must be able to recognize the Treble Clef as “right hand” and the Bass Clef as “left hand”. Start with showing the student the Treble Clef flash card. The instructor will ask, “Show me which hand?” Prompt the student to put up their right hand until the student can show the correct hand independently. Continue with the Bass Clef flash card for left hand. This task should be completed at each lesson and recorded on the Discrete Trial Record Sheets. It is important to reinforce the right and left hand not only with the flash cards, but when using the music/song book. Every time the student begins a song, the instructor should point to the clef sign in the book and ask, “Which hand is this?”.

Another step includes reinforcing the correct placement of the right and left hands, and the musical notes on the keys. When the student masters the task of right and left hand flash cards (FIG. 4), he/she is now ready for “Find the Note” flash cards (FIGS. 5 and 5A-G). Show the student one card at a time. First, the student must be able to recognize the clef sign and use the correct hand (it may be necessary to prompt the student at first). Then, with the correct hand, he/she must find the note on the keyboard (piano) that matches the card. It is also important to make sure that the student finds the correct note either to the right of middle C (right hand notes) or to the left of middle C (left hand notes). Instructor should refer to the reference chart (FIGS. 7A and 7B).

Another step is to ensure correct fingering. Correct fingering is important but not necessary in the beginning. The goal is to give the student a sense of accomplishment and to be able to play melodies. Correct fingering should be slowly introduced into the lessons by using the finger exercise pages included in the special designed music/song book. If the student is getting extremely frustrated and cannot accomplish this task, it should be left as is. The student will then play with one finger and correct fingering should be slowly incorporated into the lessons at a later time. Use the “Hands on Keys” flash card (FIG. 11) in discrete trials for reinforcement of keeping the students hands placed at the keyboard (piano keys). This will encourage the student to use all their fingers when playing the keyboard (piano keys). Tasks should be recorded and measured on the discrete trial record sheets.

Another step in the method for teaching persons with developmental disabilities how to play keyboard in accordance with the present invention includes game play. Lessons should not feel difficult or frustrating for the student. Games should be incorporated into the lessons. This will help keep the lesson fun and will also help with redirecting the student. The instructional lesson preferably should be kept to thirty (30) minutes. In the beginning, it may be hard for the student to sit for a full thirty (30) minutes. If so, break the lesson up into ten (10) minute intervals with game play in-between. As the lessons progress, the intervals can be expanded to fifteen (15) minutes and eventually the student will be able to sit for the full thirty (30) minutes.

When playing the games with the students, it is important to incorporate socialization skills. Ask the student, “Whose turn is it?” The student should respond, “Your turn.”, or “My turn.” (Depending on whose turn it is). Social interaction is important as many students with autism and developmental disabilities lack this skill.

One game that may be incorporated is the letter hunt flashlight game. This game includes 7 letter cards and a flashlight. Each card has a letter note on it (C, D, E, F, G, A, B). On the back of the card is a Velcro dot so that the card can be hung on the walls around the room. Having the Velcro dot makes it easy to change the position of the cards in the room at each lesson. Turn off the lights in the room and explain to the student that we are going on a treasure hunt for letters. Prompt the student by helping him/her shine the flashlight on the first letter at the keyboard (note C). Then, prompt the student by helping him/her to shine the flashlight around the room to find the letter card that matches the first note (letter card C). Continue to the next note D, then E, F, G, A, B. Find one letter note at a time. When the student finds each note, say the letter note and have the student repeat it (verbally). The instructor can also take turns with the student with playing this game. The instructor finds the first note and then tells the student that it is “their turn”. Ask the student, “Whose turn is it?” The student should reply, “My turn”. Not only is this game a great reinforcement for note letter recognition and order of the notes, it helps with socialization skills and it is enjoyable for the student. This game may be used at each lesson.

Another game is the keyboard chart matching game (see FIGS. 9A and 9B)—The student and the instructor sit on the floor and play a matching game with the notes and the keyboard. A cardboard keyboard is used for this game. There are two rows of Velcro secured letters for this game. When the game is first used with the student, the instructor should leave the first row of letters on. The student then matches each letter to the second row of letters. Begin with the first letter C and complete one letter match at a time (C, D, E, F, G, A, C, Middle C, D, E, F, G, A, B, C). As the student finds each letter, prompt the student by asking “What letter is this?” The student should respond verbally with the correct letter. As the student progresses, both rows of letters may be removed from the board and the student can complete the entire game independently. This game can be played taking turns with the instructor to encourage socialization skills. This game may be used at each lesson.

Another game is a memory game. Two sets of “Find the Note” flash cards (see FIGS. 5 and 5A-5G) are to be used for this game (16 cards in total). Place all sixteen cards face down on the floor. The student can complete this game independently or by taking turns with the teacher (encourage socialization). The student turns a card over and then will randomly turns another card over to see if it matches. If it does not match, both cards are turned back over and the student tries again. Complete this process until all 8 matches are found. As the student turns each card over, the instructor should always ask, “What letter note is this?” The student should respond verbally with the correct letter. This game may be used at each lesson.

Another game is the “name that note” game (see FIG. 10). This game is for students who are progressing well in the program. Once they are familiar with the musical letter notes and the order of the notes on the keys, he/she is now ready to start learning the notes on the staff and their placement on the staff. This will prepare the student for when he/she is ready to start reading notes independently and to start learning more traditional methods of piano instruction. All letter notes and both staff signs are attached to the board by using Velcro. When playing the game, remove all pieces from the board. The student can then place all the pieces back on the board in the correct order. The student can either complete this task independently or by taking turns with the instructor to encourage socialization skills. Always ask the student “What note is this?” or “What hand do you use?” (when placing the clef signs on the board). It is important to encourage socialization and language. This game may be used at each lesson.

Another step in the method is to use tangible and non-tangible reinforcements throughout the lesson. It is important to focus on the positive and consistently tell the student that he/she is doing a “Great Job”. Reward stickers should be kept on hand. A plentiful supply will be needed. They are excellent reinforcements and should be used throughout the lesson. In the beginning of the lesson, the instructor should discuss with the student what he/she will be earning at the end of the lesson. Throughout the lesson, and in all future lessons, it is important to remind the student what he/she is earning. This will help keep the student focused and on task.

Although the present invention has been described in accordance with the embodiments shown, one of ordinary skill in the art will readily recognize that there could be variations to the embodiment and these variations would be within the spirit and scope of the present invention. Accordingly, many modifications may be made by one of ordinary skill in the art without departing from the spirit and scope of the invention.

What is claimed is:

1. A method for teaching persons with developmental disorders to play songs on a keyboard comprising the steps of:
providing an instructional room which is conducive to learning;
attaching identifying indicia to keys on the keyboard;
showing the person how to play a simple song with one hand;
gradually teaching the person how to play songs with two hands;
utilizing flash cards to reinforce the proper identification of notes and keys and the proper placement of the hands; and
measuring and recording the person's progress.

2. The method as recited in claim 1 wherein the instructional room is simple and non-distracting.

3. The method as recited in claim 1 wherein the instructional room comprises a token board system to help keep the student motivated, focused, and on task.

4. The method as recited in claim 1 wherein the instructional room comprises a sign up that states “Today I am working for ______”.

5. The method as recited in claim 1 wherein the instructional room comprises at least one treasure chest.

6. The method as recited in claim 5 wherein the treasure chest is filled with at least one of lollypops and small trinkets.

7. The method as recited in claim 1 further comprising the step of placing a template along a distal end of keys on the keyboard.

8. The method as recited in claim 1 where the indicia attached to the keys are stickers with letters corresponding to the notes played by the keys.

9. The method as recited in claim 1 where the indicia attached to the keys are pictures and letters corresponding to the notes played by the keys.

10. The method as recited in claim 1 further comprising the step of playing games with the person to continue the teaching process and reinforce the items that have been learned.

11. The method as recited in claim 10 where the game includes at least one of a memory game, a letter hunt flashlight game, a name that note game, and a find the note game.

12. The method as recited in claim 1 where the person's progress is measured and recorded on discrete trial record sheets.

13. The method as recited in claim 1 wherein a total duration of completing the steps of the method is thirty minutes.

14. A kit for use in connection with a method for teaching persons with developmental disorders to play songs on a keyboard, the kit comprising:
a music/song book;
keyboard stickers for the piano keys;
templates for the piano keys;
clef flash cards;
a plurality of find the note flash cards;
discrete trial record sheets for recording and measuring the persons' progress;
reference charts for use as guides for setting up the keyboard stickers on the piano keys;
a plurality of cards having a musical note letter on each card; and
a plurality of hands on keys flash cards illustrating a plurality of hand positions on the keys.

15. The kit for use in connection with a method for teaching persons with developmental disorders to play songs on a keyboard as recited in claim 14 wherein the staff and musical notes contained in the book are oversized.

16. The kit for use in connection with a method for teaching persons with developmental disorders to play songs on a keyboard as recited in claim 14 wherein the keyboard stickers are preferably sized to fit each piano key to cover two octaves of notes.

17. The kit for use in connection with a method for teaching persons with developmental disorders to play songs on a keyboard as recited in claim 14 wherein the template fits up against the back of the keys.

18. The kit for use in connection with a method for teaching persons with developmental disorders to play songs on a keyboard as recited in claim 14 wherein the template has groves formed in the lower edge of the template to allow the template to be mounted over the black keys of the keyboard.
